(19) United States
(12) Patent Application Publication
(10) Pub. No.: US 2026/0323457 A1
(43) Pub. Date: Oct. 15, 2026

(54) MOBILITY MEASUREMENT METHOD AND APPARATUS, AND STORAGE MEDIUM

(71) Applicant: BEIJING XIAOMI MOBILE SOFTWARE CO., LTD., Beijing (CN)

(72) Inventor: Xuhua TAO, Beijing (CN)

(21) Appl. No.: 19/476,463

(22) PCT Filed: Apr. 18, 2023
(86) PCT No.: PCT/CN2023/089062

§ 371 Date: Oct. 17, 2025

(51) Int. Cl. H04W 36/30

(52) U.S. Cl. CPC H04W 36/304

(57) ABSTRACT

A method for measuring mobility, performed by a terminal, the method including: transmitting a first message to a neighboring cell; receiving a response message transmitted by the neighboring cell; and determining a mobility measurement result of the neighboring cell according to the response message, where the mobility measurement result includes a measurement result of a layer 1 (L1) mobility measurement and a measurement result of a layer 3 (L3) mobility measurement.

### CROSS-REFERENCE TO RELATED APPLICATION

The present application is a U.S. National Stage of International Application No. PCT/CN2023/089062, filed on Apr. 18, 2023, the contents of all of which are incorporated herein by reference in their entirety for all purposes.

### BACKGROUND OF THE INVENTION

In a wireless communication system, change of parameters such as signal quality of a neighbor cell is monitored through layer 3 (L3) mobility measurement or layer 1 (L1) mobility measurement, so that cell handover is performed when necessary to ensure communication quality and service continuity for a terminal during a mobile process.

### SUMMARY OF THE INVENTION

The present disclosure relates to the field of communication technologies, in particular to a method and a device for measuring mobility, and a storage medium.

According to a first aspect of the embodiments of the present disclosure, a method for measuring mobility is provided. The method is performed by a terminal and includes:
transmitting a first message to a neighbor cell;
receiving a response message transmitted by the neighbor cell; and
determining a mobility measurement result of the neighbor cell according to the response message, where the mobility measurement result includes a measurement result of a layer 1 (L1) mobility measurement and a measurement result of a layer 3 (L3) mobility measurement.

According to a second aspect of the embodiments of the present disclosure, a method for measuring mobility is provided. The method is performed by a network device and includes:
receiving a first message transmitted by a terminal; and
transmitting a response message to the terminal, where the response message is configured to determine, by the terminal, a mobility measurement result of a neighbor cell, and the mobility measurement result includes a measurement result of a layer 1 (L1) mobility measurement and a measurement result of a layer 3 (L3) mobility measurement.

According to a third aspect of the embodiments of the present disclosure, a method for measuring mobility is provided. The method is performed by a communication system. The communication system includes a terminal and a network device. The method includes:
transmitting, by the terminal, a first message to the network device, where the first message is configured to perform a layer 1 (L1) mobility measurement and a layer 3 (L3) mobility measurement on a neighbor cell;
transmitting, by the network device, a response message to the terminal; and
determining, by the terminal, a mobility measurement result of the neighbor cell according to the response message, where the mobility measurement result includes a measurement result of the L1 mobility measurement and a measurement result of the L3 mobility measurement.

According to a fourth aspect of the embodiments of the present disclosure, a terminal is provided and includes:
a transmitting module configured to transmit a first message to a neighbor cell;
a receiving module configured to receive a response message transmitted by the neighbor cell; and
a determining module configured to determine a mobility measurement result of the neighbor cell according to the response message, where the mobility measurement result includes a measurement result of a layer 1 (L1) mobility measurement and a measurement result of a layer 3 (L3) mobility measurement.

According to a fifth aspect of the embodiments of the present disclosure, a network device is provided and includes:
a receiving module configured to receive a first message transmitted by a terminal; and
a transmitting module configured to transmit a response message to the terminal, where the response message is configured to determine, by the terminal, a mobility measurement result of a neighbor cell, and the mobility measurement result includes a measurement result of a layer 1 (L1) mobility measurement and a measurement result of a layer 3 (L3) mobility measurement.

According to a sixth aspect of the embodiments of the present disclosure, a communication device is provided and includes:
one or more processors; and
a memory configured to store processor-executable instructions;
where the one or more processors are collectively configured to perform steps of the method for measuring mobility provided in the first aspect or the second aspect of the present disclosure.

According to a seventh aspect of the embodiments of the present disclosure, a non-transitory computer-readable storage medium is provided, storing computer program instructions, where the computer program instructions, when executed by one or more processors of a terminal or executed by one or more processors of a network device, cause the terminal to perform the method for measuring mobility provided in the first aspect of the present disclosure or cause the network device to perform the method for measuring mobility provided in the second aspect of the present disclosure.

According to an eighth aspect of the embodiments of the present disclosure, a communication system is provided and includes:
a terminal, where the terminal may perform the method for measuring mobility provided in the first aspect of the present disclosure; and
a network device, where the network device may perform the method for measuring mobility provided in the second aspect of the present disclosure.

### BRIEF DESCRIPTION OF DRAWINGS

Accompanying drawings in the present disclosure, incorporated in the specification and constituting part of the specification, illustrate embodiments suitable for the present disclosure and, together with the specification, serve to explain a principle of the present disclosure.

FIG. 1 is a schematic diagram of a communication system according to an example.

FIG. 2 is a flowchart of a method for measuring mobility according to an example.

FIG. 3 is a flowchart of a method for measuring mobility according to an example.

FIG. 4 is a flowchart of a method for measuring mobility according to an example.

FIG. 5 is a flowchart of a method for measuring mobility according to an example.

FIG. 6 is a flowchart of a method for measuring mobility according to an example.

FIG. 7 is a flowchart of a method for measuring mobility according to an example.

FIG. 8 is a flowchart of a method for measuring mobility according to an example.

FIG. 9 is a flowchart of a method for measuring mobility according to an example.

FIG. 10 is a flowchart of a method for measuring mobility according to an example.

FIG. 11 is a block diagram of a terminal according to an example.

FIG. 12 is a block diagram of a network device according to an example.

FIG. 13 is a block diagram of a network device according to an example.

FIG. 14 is a block diagram of a communication device according to an example.

### DETAILED DESCRIPTION OF THE INVENTION

Examples are to be described in the present disclosure in detail and shown in accompanying drawings. Unless otherwise stated, in a case where the following description refers to the accompanying drawings, the same reference numeral in different figures represents the same or similar elements. Implementations described in the following examples do not represent all implementations consistent with the present disclosure. Instead, they are merely examples of a device and method as detailed in the appended claims and consistent with some aspects of the present disclosure.

In the descriptions of the embodiments of the present disclosure, terms such as “first” and “second” are used to distinguish similar objects but are not understood as a specific sequence or a precedence order. In addition, without a contrary description, in the description with reference to the accompanying drawings, the same reference numeral in the different accompanying drawings represents the same element.

In the descriptions for the embodiments of the present disclosure, unless otherwise stated, “plurality of” refers to two or more, and other quantifiers are similar to this. “At least one,” “one or a plurality of” or their similar expressions mean that any combination of these items includes single one or any combination of a plurality of them. For example, at least one may represent any number. For another example, one or more of a, b, and c may represent: a, b, c, a-b, a-c, b-c, or a-b-c, where a, b, c may be single one or more of them. “And/or” is an association relationship for describing associated objects, which means that there may be three relationships, for example, A and/or B may mean that A exists alone, A and B exist at the same time, and B exists alone, where A and B may be singular or plural. A character “/” represents that associated objects before and after the character have an “or” relationship. A singular form “one,” “one type,” “one item,” “said,” “the,” “above-mentioned,” or “aforementioned” is also intended to include a plural form unless other meanings are stated in the context clearly.

In the descriptions of the embodiments of the present disclosure, expressions such as “in a case, A, in another case, B” and “in response to a case, A and in response to another case, B” may include the following technical solutions according to cases: A is performed irrelevant to B, namely, in some embodiments, A; B is performed irrelevant to A, namely, in some embodiments, B; A and B are performed alternatively, namely, in some embodiments, A or B is performed alternatively; and both A and B are performed, namely, in some embodiments, A and B. In a case where A, B, C, or more exist, it is similar to the above description.

In the description of the embodiments of the present disclosure, “include A,” “comprise A,” “configured to indicate A,” and “carry A” may be interpreted as directly carrying A or indirectly indicating A.

In the descriptions of the embodiments of the present disclosure, terms such as “in response to,” “in response to determining,” “in a case where,” “when,” “while,” “as if,” and “if” are interchangeable.

In some embodiments, terms such as “greater than,” “greater than or equal to,” “or above,” “higher than,” and “not less than” are interchangeable. Terms such as “less than,” “less than or equal to,” “or below,” “lower than,” and “not greater than” are interchangeable.

In some embodiments, “predetermine” and “preset” may be interpreted as pre-regulating in a protocol or presetting an action by a device or the like.

In some embodiments, the device or the like may be interpreted as an entity or virtual and has a name not limited to a name recorded in the embodiments, and terms such as “apparatus,” “equipment,” “device,” “network element,” “node,” “function,” “unit,” “entity,” “system,”“chip,” “system on chip,” and “main body” are interchangeable.

In some embodiments, a name for information, etc., is not limited to a name recorded in the embodiments, and terms such as “information,” “message,” “signaling,” “report,” “configuration,” “indication,” “parameter,” and “data” are interchangeable.

In some embodiments, terms such as “instruction” and “program” are interchangeable.

In some embodiments, “acquire,” “obtain,” “possess,” “receive,” and “transmit (send and/or receive)” are interchangeable and may be interpreted as many meanings such as receiving from other main bodies, acquiring from a protocol, obtaining by self-processing, and self-implementing.

In some embodiments, “send,” “report,” “issue,” and “transmit (send and/or receive)” are interchangeable.

In some embodiments, to obtain data, information and the like may comply with laws and regulations of a country where it is located.

In some embodiments, data, information, and the like may be obtained with user's permission.

In addition, each element, each row, or each column in a table of the embodiments of the present disclosure may be implemented as an independent embodiment, and a combination of any element, any row, and any column may also be implemented as an independent embodiment.

Though operations or steps are described in a specific sequence in the embodiments or accompanying drawings of the present disclosure, it is not to be understood as requiring to perform these operations or steps in the shown specific sequence or a serial sequence, or requiring to perform all shown operations or steps so as to obtain expected results. In the embodiments of the present disclosure, without contradictions, these operations or steps may be performed in any sequence; these operations or steps may also be performed in parallel; part of these operations or steps may also be performed; and operations or steps in a plurality of embodiments or accompanying drawings may also be combined at will, which is not limited by the embodiments of the present disclosure.

It is to be noted that the embodiments of the present disclosure are not exhaustive and are merely illustrations of part of embodiments without serving as a specific limitation on the protection scope of the present disclosure. Without contradictions, each step in a certain embodiment may be implemented as an independent embodiment, the respective steps may be combined at will, for example, a solution with some steps removed in a certain embodiment may also be implemented as an independent embodiment, and respective steps may be interchanged at will in order in a certain embodiment. In addition, optional implementations in a certain embodiment may be combined at will. Besides, the various embodiments may be combined at will, for example, some steps or all steps in different embodiments may be combined at will, and a certain embodiment may be combined with optional implementations of the other embodiments at will.

Implementation environments of the embodiments of the present disclosure are introduced below.

Technical solutions of the embodiments of the present disclosure may be applied to various communication systems. The communication system may include one or more of a 4th generation (4G) communication system, a 5th generation (5G) communication system, and other future wireless communication systems (such as 6G). The communication system may also include one or more of a public land mobile network (PLMN), a device-to-device (D2D) communication system, a machine-to-machine (M2M) communication system, an Internet of Things (IoT) communication system, a Vehicle-to-Everything (V2X) communication system, or other communication systems.

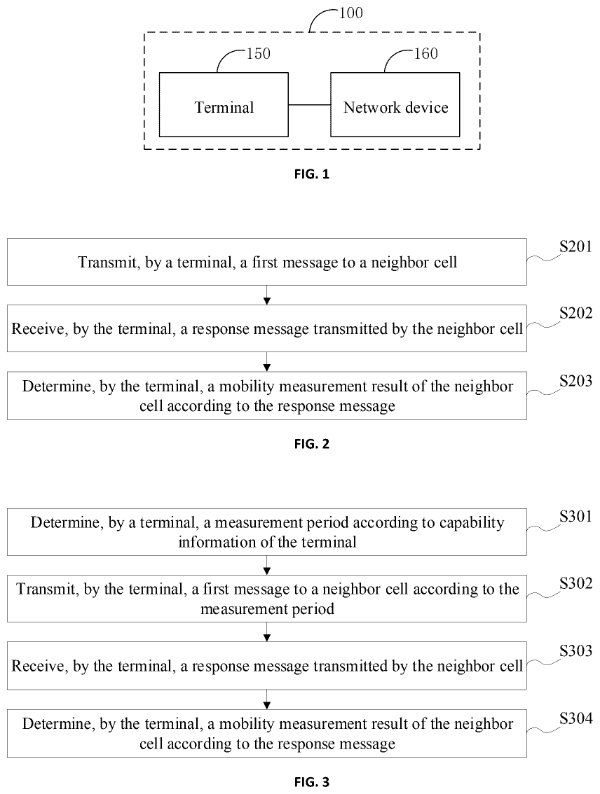

FIG. 1 is a schematic diagram of a communication system 100 according to an example. As shown in FIG. 1, the communication system 100 may include a terminal 150 and a network device 160. The communication system 100 may be configured to support a 4G network access technology, for example, a long term evolution (LTE) access technology, or a 5G network access technology, such as a new radio access technology (New RAT), or other future wireless communication technologies. It is to be noted that in the communication system 100, there may be one or more network devices 160 and one or more terminals 150. The number of the network devices 160 and the number of the terminals 150 of the communication system 100 shown in FIG. 1 are merely an adaptive example, which is not limited by the embodiments of the present disclosure.

The network device 160 in FIG. 1 may be configured to support terminal 150 access. For example, the network device 160 may include an evolutional Node B (eNB or eNodeB) in LTE. The network device 160 may also include a next generation Node B (gNB or gNodeB) in a 5G network. The network device 160 may also include an NG-radio access network (NG-RAN) device in the 5G network. The network device 160 may also include at least one of a base station, a broadband network gateway (BNG), an aggregation switch or a non-3GPP access device, or other devices in a future evolution public land mobile network (PLMN). In some examples, the network device 160 in the embodiments of the present disclosure may include at least one of the following various forms of base stations, for example: a macro base station, a micro base station (also called a small station), a relay station, an access point, a 5G base station or a future base station, a satellite, a transmitting and receiving point (TRP), a transmitting point (TP), a mobile switching center and device-to-device (D2D), machine-to-machine (M2M), Internet of Things (IoT), Vehicle-to-Everything (V2X) or other devices carrying base station functions in the communication system, which is not limited by the embodiments of the present disclosure. For facilitating descriptions, in the embodiments of the present disclosure, a device for providing a wireless communication function for the terminal 150 is generally called the network device 160 or the base station.

The terminal 150 in FIG. 1 may be an electronic device for providing speech or data connectivity. For example, the terminal 150 may be called a user equipment (UE), a subscriber unit, a mobile station, a station, a terminal, or the like. For example, the terminal 150 may include a smart phone, a smart wearable device, a smart speaker, a smart tablet, a wireless modem, a wireless local loop (WLL) station, a personal digital assistant (PDA), customer premise equipment (CPE), or the like. With development of a wireless communication technology, a device that may access into the communication system 100, may communicate with the network device 160 of the communication system 100, may communicate with other objects through the communication system, or may directly communicate between two or more devices may be the terminal 150 in the embodiments of the present disclosure, for example, a terminal 150 and a vehicle in intelligent transportation, a household appliance in smart home, an electricity meter reading instrument, a voltage monitoring instrument and an environment monitoring instrument in smart grid, a video monitoring instrument and a cashing machine in an intelligent security network, or the like. In the embodiments of the present disclosure, the terminal 150 may communicate with the network device 160. A plurality of terminals may also communicate with each other. The terminal 150 may be static or mobile, which is not limited by the embodiments of the present disclosure.

A layer 3 (L3) mobility measurement is that through communication with a neighbor cell, the terminal compares parameters such as quality and strength of a signal of the neighbor cell with those of a signal of a current serving cell so as to evaluate whether it needs to switch to a neighbor cell with a better service, so that communication quality and communication efficiency are improved. A layer 1 (L1) mobility measurement is that the terminal evaluates channel quality of a current connection by measuring physical signal parameters such as signal strength, a signal-to-noise ratio, and delay of the serving cell and the neighbor cell so as to adjust a transmission power or select a better physical channel, and thus communication quality is improved.

An L1 mobility measurement process may include: the terminal communicating with the neighbor cell through physical layer signaling, obtaining a physical signal parameter of the neighbor cell, comparing the obtained physical signal parameter with a predefined threshold value and transmitting a comparison result to the network device to which the terminal is currently connected. The network device may select a best neighbor cell for switching according to the received signal parameter comparison result and a system configuration parameter.

An L3 mobility measurement process may include: the terminal scanning the neighbor cell within a specified time interval, obtaining physical signal parameters of the neighbor cell, and transmitting, through a radio resource control (RRC) message, the obtained physical signal parameters of the neighbor cell to the network device to which the terminal is currently connected. Then the network device transmits these physical signal parameters to a mobility management entity (MME) or a serving general packet radio service support node (SGSN). The MME or the SGSN, after receiving the RRC message, may parse the RRC message and may transmit a measurement report of the neighbor cell to the network device to which it is currently connected. The network device may select a best neighbor cell for switching according to the measurement report and a system configuration parameter of the neighbor cell.

FIG. 2 is a flowchart of a method for measuring mobility according to an example. The method may be performed by a terminal in a communication system. As shown in FIG. 2, the method may include steps S201 to S203.

In S201, the terminal transmits a first message to a neighbor cell.

In some embodiments, the neighbor cell may include an intra-frequency neighbor cell and an inter-frequency neighbor cell.

In some embodiments, the first message may be configured to perform an L1 mobility measurement and an L3 mobility measurement on the neighbor cell. For example, the first message may include a downlink synchronizing signal, a downlink reference signal, a measurement signal, or the like. The embodiments of the present disclosure do not limit a type of the first message.

In some embodiments, the terminal transmits the first message to the neighbor cell after receiving a measurement trigger message transmitted by a currently connected network device.

In S202, the terminal receives a response message transmitted by the neighbor cell.

In some embodiments, the response message may be a measurement report. For example, the measurement report may include a signal strength and a signal-to-noise ratio. The present disclosure does not limit a specific type of the response message.

In S203, the terminal determines a mobility measurement result of the neighbor cell according to the response message.

The mobility measurement result may include a measurement result of the L1 mobility measurement and a measurement result of the L3 mobility measurement.

In some embodiments, the terminal, after receiving the response message transmitted by the neighbor cell, may determine the mobility measurement result of the neighbor cell according to the response message and a preset threshold value.

In an implementation, in a case where the response message includes the signal strength, the mobility measurement result may be a comparison result between the signal strength of the neighbor cell included in the response message and a preset signal strength threshold. The comparison result may reflect the service quality of the neighbor cell.

In this way, the terminal, after transmitting the first message to the neighbor cell, may determine the measurement result of the L1 mobility measurement and the measurement result of the L3 mobility measurement through the response message transmitted by the neighbor cell. A problem of too many interruptions or prolonged interruptions of a serving cell caused by separately performing the L1 mobility measurement and the L3 mobility measurement is avoided, and thus serving cell throughput and network mobility performance are improved.

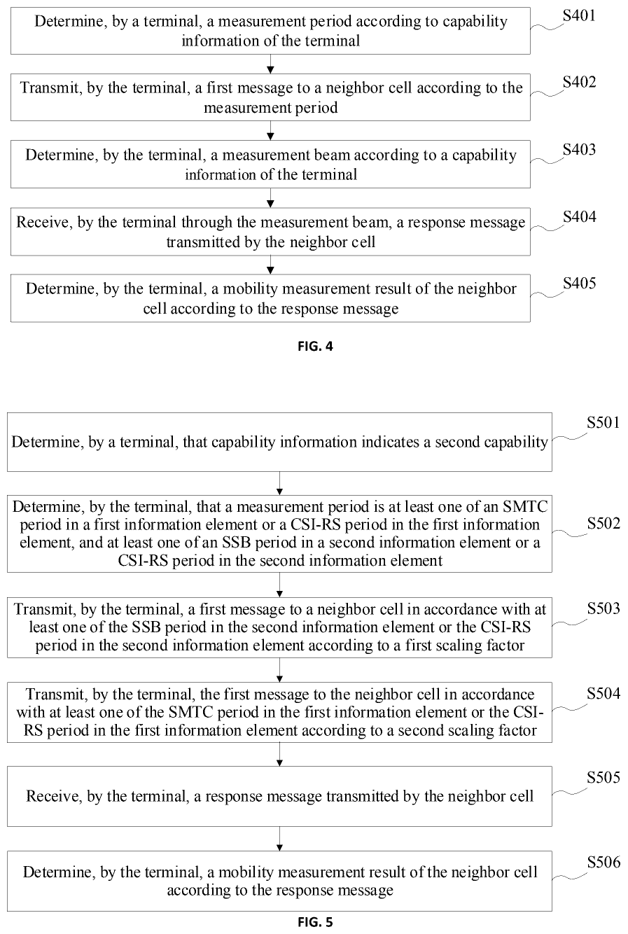

FIG. 3 is a flowchart of a method for measuring mobility according to an example. The method may be performed by a terminal in a communication system. As shown in FIG. 3, the method may include S301 to S304.

In S301, the terminal determines a measurement period according to capability information of the terminal.

In some embodiments, the capability information may be configured to indicate at least one of the following:
whether the terminal has a capability of determining the mobility measurement result according to the response message received by a specified beam, where the specified beam is any beam of a rough beam or a fine beam;
whether the terminal has a capability of receiving the response message by simultaneously using the rough beam and the fine beam;
whether the terminal has a capability of determining the measurement result of the L1 mobility measurement according to the response message received by the rough beam; or
whether the terminal has a capability of determining the measurement result of the L3 mobility measurement according to the response message received by the fine beam.

The rough beam may be a rough Rx beam. The fine beam may be a fine Rx beam.

In some embodiments, it is determined that the capability information indicates a first capability; and it is determined that the measurement period is at least one of a service measurement timing configuration (SMTC) period in a first information element or a channel state information reference signal (CSI-RS) period in the first information element, where the first information element is an information element measurement object for new radio (IE MeasObjectNR).

The first capability may include at least one of the following: the terminal has the capability of determining the mobility measurement result according to the response message received by the specified beam; the terminal has the capability of receiving the response message by simultaneously using the rough beam and the fine beam; or the terminal has the capability of determining the measurement result of the L1 mobility measurement according to the response message received by the rough beam.

In an implementation, in a case of determining that the capability information indicates that the terminal has the capability of determining the mobility measurement result according to the response message received by the specified beam, it may be determined that the measurement period is at least one of the SMTC period in the first information element or the CSI-RS period in the first information element.

For example, in a case where the terminal has the capability of determining the mobility measurement result according to the response message received by the rough beam and has the capability of determining the mobility measurement result according to the response message received by the fine beam, it may be determined that the measurement period is at least one of the SMTC period in the first information element or the CSI-RS period in the first information element.

In another implementation, in a case of determining that the capability information indicates that the terminal has the capability of receiving the response message by simultaneously using the rough beam and the fine beam, it may be determined that the measurement period is at least one of the SMTC period in the first information element or the CSI-RS period in the first information element.

For example, in a case where a network device transmits the response message, and the terminal may receive the response message at the same time through the rough beam and the fine beam, it may be determined that the measurement period is at least one of the SMTC period in the first information element or the CSI-RS period in the first information element.

In another implementation, in a case of determining that the capability information indicates that the terminal has the capability of determining the measurement result of the L1 mobility measurement according to the response message received by the rough beam, it may be determined that the measurement period is at least one of the SMTC period in the first information element or the CSI-RS period in the first information element.

For example, in a case where the terminal has the capability of determining the measurement result of the L1 mobility measurement according to the response message received by the rough beam but does not have the capability of determining the measurement result of the L3 mobility measurement according to the response message received by the fine beam, it may be determined that the measurement period is at least one of the SMTC period in the first information element or the CSI-RS period in the first information element.

It is to be noted that in a case of determining that the capability information indicates more items in the first capability, it may also be determined that the measurement period is at least one of the SMTC period in the first information element or the CSI-RS period in the first information element.

In some other embodiments, it is determined that the capability information indicates that the terminal has the capability of determining the measurement result of the L3 mobility measurement according to the response message received by the fine beam; and it is determined that the measurement period is at least one of a synchronization signal block (SSB) period in a second information element or a CSI-RS period in the second information element, where the second information element is an information element channel state information-synchronization signal block resource set (IE csi-SSB-ResourceSet).

For example, in a case where the terminal has the capability of determining the measurement result of the L3 mobility measurement according to the response message received by the fine beam but does not have the capability of determining the measurement result of the L1 mobility measurement according to the response message received by the rough beam, it may be determined that the measurement period is at least one of the SSB period in the second information element or the CSI-RS period in the second information element.

In S302, the terminal transmits a first message to the neighbor cell according to the measurement period.

In some embodiments, the terminal may transmit the first message to the neighbor cell in a downlink control channel (DCCH) or a downlink shared channel (DL-SCH) within the SMTC period of the IE MeasObjectNR.

In some other embodiments, the terminal may transmit the first message to the neighbor cell in a physical downlink control channel (PDCCH) within the CSI-RS period of the IE csi-SSB-ResourceSet.

It is to be noted that the channel for the terminal to transmit the first message to the neighbor cell is an example, which is not limited by the embodiment of the present disclosure.

In S303, the terminal receives the response message transmitted by the neighbor cell.

In some embodiments, the terminal may receive the response message transmitted by the neighbor cell in the DCCH or the DL-SCH within the SMTC period of the IE MeasObjectNR.

In some other embodiments, the terminal may receive the response message transmitted by the neighbor cell in the PDCCH within the CSI-RS period of the IE csi-SSB-ResourceSet.

It is to be noted that the channel for the terminal to receive the response message transmitted by the neighbor cell is an example, which is not limited by the embodiment of the present disclosure.

In S304, the terminal determines a mobility measurement result of the neighbor cell according to the response message.

The mobility measurement result may include the measurement result of the L1 mobility measurement and the measurement result of the L3 mobility measurement.

In some embodiments, the response message may be a measurement report. The terminal may determine the mobility measurement result according to the measurement report and a preset threshold.

In some embodiments, the terminal may parse the response message according to a type of a beam for receiving the response message, and respectively determine the measurement result of the L1 mobility measurement and the measurement result of the L3 mobility measurement according to a preset measurement algorithm. A measurement algorithm corresponding to the L1 mobility measurement may be different from a measurement algorithm corresponding to the L3 mobility measurement.

By using the method, the terminal may determine the measurement period based on the capability information and transmit the first message to the neighbor cell through the measurement period.

FIG. 4 is a flowchart of a method for measuring mobility according to an example. The method may be performed by a terminal in a communication system. As shown in FIG. 4, the method may include S401 to S405.

In S401, the terminal determines a measurement period according to capability information of the terminal.

In some embodiments, the capability information may be configured to indicate at least one of the following:
whether the terminal has a capability of determining a mobility measurement result according to a response message received by a specified beam, where the specified beam is any beam of a rough beam or a fine beam;
whether the terminal has a capability of receiving the response message by simultaneously using the rough beam and the fine beam;
whether the terminal has a capability of determining a measurement result of an L1 mobility measurement according to the response message received by the rough beam; or
whether the terminal has a capability of determining a measurement result of an L3 mobility measurement according to the response message received by the fine beam.

The rough beam may be a rough Rx beam. The fine beam may be a fine Rx beam.

In S402, the terminal transmits a first message to a neighbor cell according to the measurement period.

In some embodiments, the terminal may transmit the first message to the neighbor cell in a DCCH or a DL-SCH within an SMTC period of an IE MeasObjectNR.

In some other embodiments, the terminal may transmit the first message to the neighbor cell in a PDCCH within a CSI-RS period of an IEcsi-SSB-ResourceSet.

It is to be noted that the channel for the terminal to transmit the first message to the neighbor cell is an example, which is not limited by the embodiment of the present disclosure.

In S403, the terminal determines a measurement beam according to the capability information of the terminal.

In some embodiments, the capability information indicates that the terminal has the capability of determining the mobility measurement result according to the response message received by the specified beam. It is determined that the measurement beam is the specified beam, and the specified beam is any beam of the rough beam or the fine beam.

For example, in a case where the terminal may determine the mobility measurement result according to the response message received by any beam of the rough beam or the fine beam, it may be determined that the measurement beam is any beam of the rough beam or the fine beam.

In some other embodiments, the capability information indicates that the terminal has the capability of receiving the response message by simultaneously using the rough beam and the fine beam; and it is determined that the measurement beam is the rough beam and the fine beam.

In some other embodiments, the capability information indicates that the terminal has the capability of determining the measurement result of the L1 mobility measurement according to the response message received by the rough beam; and it is determined that the measurement beam is the rough beam.

For example, in a case where the terminal may determine the measurement result of the L1 mobility measurement according to the response message received by the rough beam but may not determine the measurement result of the L3 mobility measurement according to the response message received by the fine beam, it may be determined that the measurement beam is the rough beam.

In some other embodiments, the capability information indicates that the terminal has the capability of determining the measurement result of the L3 mobility measurement according to the response message received by the fine beam; and it is determined that the measurement beam is the fine beam.

For example, in a case where the terminal may determine the measurement result of the L3 mobility measurement according to the response message received by the fine beam but cannot determine the measurement result of the L1 mobility measurement according to the response message received by the rough beam, it may be determined that the measurement beam is the fine beam.

In S404, the terminal receives, through the measurement beam, the response message transmitted by the neighbor cell.

In some embodiments, the terminal may receive, through the measurement beam, the response message transmitted by the neighbor cell in the DCCH or the DL-SCH within the SMTC period of the IE MeasObjectNR.

In some other embodiments, the terminal may receive, through the measurement beam, the response message transmitted by the neighbor cell in the PDCCH within the CSI-RS period of the IE csi-SSB-ResourceSet.

It is to be noted that the channel for the terminal to receive the response message transmitted by the neighbor cell is an example, which is not limited by the embodiment of the present disclosure.

In S405, the terminal determines a mobility measurement result of the neighbor cell according to the response message.

The mobility measurement result may include the measurement result of the L1 mobility measurement and the measurement result of the L3 mobility measurement.

In some embodiments, the response message may be a measurement report. The terminal may determine the mobility measurement result according to the measurement report and a preset threshold.

In some embodiments, the terminal may parse the response message according to the measurement beam, and may respectively determine the measurement result of the L1 mobility measurement and the measurement result of the L3 mobility measurement according to a type of the measurement beam and a parsed response message. The type of the measurement beam may include the rough beam and the fine beam.

For example, different types of measurement beams may correspond to different measurement algorithms. The measurement algorithms may include a first measurement algorithm and a second measurement algorithm. The measurement result of the L1 mobility measurement is determined through the first measurement algorithm according to the parsed response message. The measurement result of the L3 mobility measurement is determined through the second measurement algorithm according to the parsed response message.

It is to be noted that without contradictions, the present embodiment may be combined with the above embodiments or implementations and various optional solutions of the present disclosure. In the present embodiment, specific implementations of the above steps may also refer to the descriptions in the above embodiments of the present disclosure, which is not repeated in the present disclosure.

In this way, the terminal may determine the measurement beam according to the capability information, and may receive, through the measurement beam, the response message transmitted by the neighbor cell.

FIG. 5 is a flowchart of a method for measuring mobility according to an example. The method may be performed by the terminal in the communication system. As shown in FIG. 5, the method may include S501 to S506.

In S501, the terminal determines that capability information indicates a second capability.

The second capability includes: the terminal does not have a capability of determining a mobility measurement result according to a response message received by a specified beam, where the specified beam is any beam of a rough beam or a fine beam; the terminal does not have a capability of receiving the response message by simultaneously using the rough beam and the fine beam; the terminal does not have a capability of determining a measurement result of an L1 mobility measurement according to the response message received by the rough beam; and the terminal does not have a capability of determining a measurement result of an L3 mobility measurement according to the response message received by the fine beam.

The rough beam may be a rough Rx beam. The fine beam may be a fine Rx beam.

It is to be noted that in a case where the capability information of the terminal indicates the second capability, it means that the terminal may determine the measurement result of the L3 mobility measurement according to the response message received by the rough beam and may determine the measurement result of the L1 mobility measurement according to the response message received by the fine beam, and the terminal does not have a capability of simultaneously using the rough beam and the fine beam. In this case, the terminal needs to respectively transmit two first messages for performing the L1 mobility measurement and the L3 mobility measurement, the terminal needs to be configured with slots for respectively receiving two response messages transmitted by a neighbor cell according to the two first messages, an interruption of a serving cell is caused, and serving cell throughput and network mobility performance are affected.

In S502, the terminal determines that a measurement period is at least one of an SMTC period or a CSI-RS period in a first information element, and at least one of an SSB period or a CSI-RS period in a second information element.

The first information element is an IE MeasObjectNR. The second information element is an IE csi-SSB-ResourceSet.

In S503, the terminal transmits a first message to a neighbor cell in accordance with at least one of the SSB period or the CSI-RS period in the second information element according to a first scaling factor.

The first scaling factor is determined according to a number of first carriers performing the L1 mobility measurement and a number of carriers performing the L3 mobility measurement on the first carriers.

In an implementation, the first scaling factor may represent a measurement delay of the L1 mobility measurement.

In some embodiments, the terminal may transmit, through the fine beam, the first message to the neighbor cell in a PDCCH within the CSI-RS period of the IE csi-SSB-ResourceSet.

It is to be noted that the channel for the terminal to transmit the first message to the neighbor cell is an example, which is not limited by the embodiment of the present disclosure.

In S504, the terminal transmits the first message to the neighbor cell in accordance with at least one of the SMTC period in the first information element or the CSI-RS period in the first information element according to a second scaling factor.

The second scaling factor is determined according to a number of second carriers performing the L3 mobility measurement and a number of carriers performing the L1 mobility measurement on the second carriers.

In an implementation, the second scaling factor may represent a measurement delay of the L1 mobility measurement.

In some embodiments, the terminal may transmit, through the rough beam, the first message to the neighbor cell in a DCCH or a DL-SCH within the SMTC period of the IE MeasObjectNR.

It is to be noted that the channel for the terminal to transmit the first message to the neighbor cell is an example, which is not limited by the embodiment of the present disclosure.

It is to be noted that the steps S501 and S502 may be performed independently, and the steps S503 and S504 may also be performed independently, which is not limited by the embodiment of the present disclosure. A sequence of performing the steps S503 and S504 is an example, and the embodiment of the present disclosure does not limit the sequence of performing the steps S503 and S504.

In S505, the terminal receives a response message transmitted by the neighbor cell.

In some embodiments, the response message includes a first response message and a second response message. The first response message transmitted by the neighbor cell may be received through the fine beam. The second response message transmitted by the neighbor cell may be received through the rough beam.

In some embodiments, the terminal may receive, through the fine beam, the first response message transmitted by the neighbor cell in the PDCCH within the CSI-RS period of the IE csi-SSB-ResourceSet.

In some other embodiments, the terminal may receive, through the rough beam, the second response message transmitted by the neighbor cell in the DCCH or the DL-SCH within the SMTC period of the IE MeasObjectNR.

It is to be noted that the channels for the terminal to receive the first response message and the second response message transmitted by the neighbor cell is an example, which is not limited by the embodiment of the present disclosure.

In S506, the terminal determines a mobility measurement result of the neighbor cell according to the response message.

The mobility measurement result may include the measurement result of the L1 mobility measurement and the measurement result of the L3 mobility measurement.

In some embodiments, the response message may be a measurement report. The terminal may determine the mobility measurement result according to the measurement report and a preset threshold.

In some embodiments, the measurement result of the L1 mobility measurement may be determined according to the first response message; and the measurement result of the L3 mobility measurement may be determined according to the second response message.

In an implementation, the terminal may parse the first response message according to a parsing algorithm corresponding to the fine beam and may determine the measurement result of the L1 mobility measurement according to a preset first measurement algorithm. Further, the terminal may parse the second response message according to a parsing algorithm corresponding to the rough beam and determine the measurement result of the L3 mobility measurement according to a preset second measurement algorithm.

It is to be noted that without contradictions, the present embodiment may be combined with the above embodiments or implementations and various optional solutions of the present disclosure. In the present embodiment, specific implementations of the above steps may also refer to the descriptions in the above embodiments of the present disclosure, which is not repeated in the present disclosure.

By using the method, the terminal may respectively transmit two first messages according to the first scaling factor and the second scaling factor. Further, the terminal may receive, through the fine beam, the first response message transmitted by the neighbor cell, and receive, through the rough beam, the second response message transmitted by the neighbor cell. As the first scaling factor is determined according to the number of the first carriers performing the L1 mobility measurement and the number of the carriers performing the L3 mobility measurement on the first carriers, a process of receiving, by the terminal through the fine beam, the first response message is not interrupted by the second response message. The second scaling factor is determined according to the number of the second carriers performing the L3 mobility measurement and the number of the carriers performing the L1 mobility measurement on the second carriers, so a process of receiving, by the terminal through the rough beam, the second response message is not interrupted by the first response message. Thus, the serving cell throughput and the network mobility performance are improved.

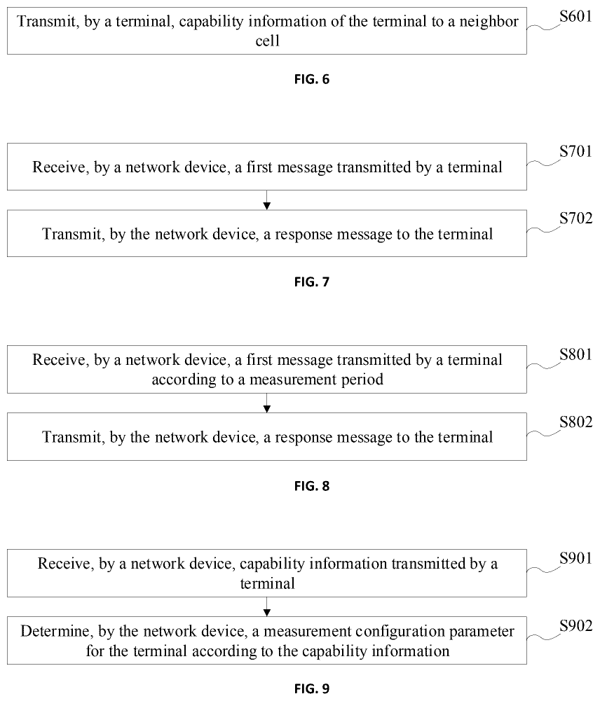

FIG. 6 is a flowchart of a method for measuring mobility according to an example. The method may be performed by a terminal in a communication system. As shown in FIG. 6, the method may include S601.

In S601, the terminal transmits capability information of the terminal to a neighbor cell.

The capability information may be configured to determine a measurement configuration parameter for the terminal.

In some embodiments, the terminal may transmit the capability information of the terminal to the neighbor cell before transmitting a first message to the neighbor cell.

In some other embodiments, the terminal may also transmit the capability information of the terminal to the neighbor cell after receiving a response message transmitted by the neighbor cell.

It is to be noted that the present disclosure does not limit a time point of transmitting, by the terminal, the capability information.

In this way, after the terminal transmits the capability information to a network device, the network device may perform a measurement configuration according to the capability information.

FIG. 7 is a flowchart of a method for measuring mobility according to an example. The method may be performed by the network device in the communication system. As shown in FIG. 7, the method may include S701 and S702.

In S701, the network device receives a first message transmitted by a terminal.

In some embodiments, the neighbor cell may include an intra-frequency neighbor cell and an inter-frequency neighbor cell.

In some embodiments, the first message may be configured to perform a L1 mobility measurement and a L3 mobility measurement on the neighbor cell. For example, the first message may include a downlink synchronizing signal, a downlink reference signal, a measurement signal, or the like. The embodiment of the present disclosure does not limit a type of the first message.

In some embodiments, the first message transmitted by the terminal may be received after the terminal receives a measurement trigger message transmitted by a currently connected network device.

In some embodiments, the network device may receive the first message transmitted by the terminal according to a measurement period, where the measurement period is determined according to capability information of the terminal.

In some embodiments, the capability information is configured to indicate at least one of the following: whether the terminal has a capability of determining a mobility measurement result according to a response message received by a specified beam, where the specified beam is any beam of a rough beam or a fine beam; whether the terminal has a capability of receiving the response message by simultaneously using the rough beam and the fine beam; whether the terminal has a capability of determining a measurement result of the L1 mobility measurement according to the response message received by the rough beam; or whether the terminal has a capability of determining a measurement result of the L3 mobility measurement according to the response message received by the fine beam.

The rough beam may be a rough Rx beam. The fine beam may be a fine Rx beam.

In some embodiments, the measurement period is determined through the following manner: determining that the capability information indicates a first capability; and determining that the measurement period is at least one of a service measurement timing configuration (SMTC) period in a first information element or a channel state information reference signal (CSI-RS) period in a first information element, where the first information element is an IE MeasObjectNR. The first capability includes at least one of the following: the terminal has the capability of determining the mobility measurement result according to the response message received by the specified beam; the terminal has the capability of receiving the response message by simultaneously using the rough beam and the fine beam; or the terminal has the capability of determining the measurement result of the L1 mobility measurement according to the response message received by the rough beam.

In an implementation, in a case of determining that the capability information indicates that the terminal has the capability of determining the mobility measurement result according to the response message received by the specified beam, it may be determined that the measurement period is at least one of the SMTC period in the first information element or the CSI-RS period in the first information element.

For example, in a case where the terminal has the capability of determining the mobility measurement result according to the response message received by the rough beam and has the capability of determining the mobility measurement result according to the response message received by the fine beam, it may be determined that the measurement period is at least one of the SMTC period in the first information element or the CSI-RS period in the first information element.

In another implementation, in a case of determining that the capability information indicates that the terminal has the capability of receiving the response message by simultaneously using the rough beam and the fine beam, it may be determined that the measurement period is at least one of the SMTC period in the first information element or the CSI-RS period in the first information element.

For example, in a case where the network device transmits the response message, and the terminal may receive the response message at the same time through the rough beam and the fine beam, it may be determined that the measurement period is at least one of the SMTC period in the first information element or the CSI-RS period in the first information element.

In another implementation, in a case of determining that the capability information indicates that the terminal has the capability of determining the measurement result of the L1 mobility measurement according to the response message received by the rough beam, it may be determined that the measurement period is at least one of the SMTC period in the first information element or the CSI-RS period in the first information element.

For example, in a case where the terminal has the capability of determining the measurement result of the L1 mobility measurement according to the response message received by the rough beam but does not have the capability of determining the measurement result of the L3 mobility measurement according to the response message received by the fine beam, it may be determined that the measurement period is at least one of the SMTC period in the first information element or the CSI-RS period in the first information element.

It is to be noted that in a case of determining that the capability information indicates more items in the first capability, it may also be determined that the measurement period is at least one of the SMTC period in the first information element or the CSI-RS period in the first information element.

In some other embodiments, the measurement period is determined through the following manner: determining that the capability information indicates that the terminal has the capability of determining the measurement result of the L3 mobility measurement according to the response message received by the fine beam; and determining that the measurement period is at least one of a synchronization signal block (SSB) period in a second information element or a CSI-RS period in the second information element, where the second information element is an IE csi-SSB-ResourceSet.

For example, in a case where the terminal has the capability of determining the measurement result of the L3 mobility measurement according to the response message received by the fine beam but does not have the capability of determining the measurement result of the L1 mobility measurement according to the response message received by the rough beam, it may be determined that the measurement period is at least one of the SSB period in the second information element or the CSI-RS period in the second information element.

In some embodiments, the first message may be received by the network device in a downlink control channel (DCCH) or a downlink shared channel (DL-SCH) within the SMTC period of the IE MeasObjectNR.

In some other embodiments, the first message may be received by the network device in a physical downlink control channel (PDCCH) within the CSI-RS period of the IE csi-SSB-ResourceSet.

It is to be noted that the channel for the network device to receive the first message is an example, which is not limited to the embodiment of the present disclosure.

In S702, the network device transmits a response message to the terminal.

The response message may be configured to determine, by the terminal, the mobility measurement result of the neighbor cell.

The mobility measurement result may include the measurement result of the L1 mobility measurement and the measurement result of the L3 mobility measurement.

In some embodiments, the response message may be a measurement report. For example, the measurement report may include a signal strength and a signal-to-noise ratio. The present disclosure does not limit a specific type of the response message.

In some embodiments, after the response message is transmitted to the terminal, the terminal may determine the mobility measurement result of the neighbor cell according to the response message and a preset threshold value.

In an implementation, in a case where the response message includes the signal strength, the mobility measurement result may be a comparison result between the signal strength of the neighbor cell included in the response message and a preset signal strength threshold. The comparison result may reflect service quality of the neighbor cell.

In some embodiments, the network device may transmit the response message in the DCCH or the DL-SCH within the SMTC period of the IE MeasObjectNR.

In some other embodiments, the network device may transmit the response message in the PDCCH within the CSI-RS period of the IE csi-SSB-ResourceSet.

It is to be noted that the channel for the network device to transmit the response message is an example, which is not limited to the embodiment of the present disclosure. Without contradictions, the present embodiment may be combined with the above embodiments or implementations and various optional solutions of the present disclosure. In the present embodiment, specific implementations of the above steps may also refer to the descriptions in the above embodiments of the present disclosure, which is not repeated in the present disclosure.

In this way, the network device, after receiving the first message transmitted by the terminal, may transmit the response message to the terminal, and the terminal may determine the measurement result of the L1 mobility measurement and the measurement result of the L3 mobility measurement according to the response message. A problem of too many interruptions or prolonged interruptions of a serving cell caused by separately performing the L1 mobility measurement and the L3 mobility measurement is avoided, and thus serving cell throughput and network mobility performance are improved.

FIG. 8 is a flowchart of a method for measuring mobility according to an example. The method may be performed by the network device in the communication system. As shown in FIG. 8, the method may include S801 and S802.

In S801, the network device receives a first message transmitted by a terminal according to a measurement period.

In some embodiments, the first message may be configured to perform a layer 1 (L1) mobility measurement and a layer 3 (L3) mobility measurement on a neighbor cell. For example, the first message may include a downlink synchronizing signal, a downlink reference signal, a measurement signal, or the like. The embodiment of the present disclosure does not limit a type of the first message.

In some embodiments, the measurement period is determined through the following manner: determining that the capability information indicates a second capability; and determining that the measurement period is at least one of an SMTC period in a first information element or a CSI-RS period in the first information element, and at least one of an SSB period in a second information element or a CSI-RS period in the second information element, where the first information element is an IE MeasObjectNR, and the second information element is an IE csi-SSB-ResourceSet. The second capability includes: the terminal does not have a capability of determining a mobility measurement result according to a response message received by a specified beam, where the specified beam is any beam of a rough beam or a fine beam; the terminal does not have a capability of receiving the response message by simultaneously using the rough beam and the fine beam; the terminal does not have a capability of determining a measurement result of the L1 mobility measurement according to the response message received by the rough beam; and the terminal does not have a capability of determining a measurement result of the L3 mobility measurement according to the response message received by the fine beam.

The rough beam may be a rough Rx beam. The fine beam may be a fine Rx beam.

It is to be noted that in a case where the capability information of the terminal indicates the second capability, it means that the terminal may determine the measurement result of the L3 mobility measurement according to the response message received by the rough beam and may determine the measurement result of the L1 mobility measurement according to the response message received by the fine beam, and the terminal does not have a capability of simultaneously using the rough beam and the fine beam. In this case, the terminal needs to respectively transmit two first messages for performing the L1 mobility measurement and the L3 mobility measurement, the terminal needs to receive, at intervals, two response messages transmitted by the neighbor cell according to the two first messages, an interruption of a serving cell is caused, and serving cell throughput and network mobility performance are affected.

In some embodiments, the network device may receive a first message that is transmitted by the terminal in accordance with at least one of the SSB period in the second information element or the CSI-RS period in the second information element according to a first scaling factor and receive a first message that is transmitted by the terminal in accordance with at least one of the SMTC period in the first information element or the CSI-RS period in the first information element according to a second scaling factor. The first scaling factor is determined by the terminal according to a number of first carriers performing the L1 mobility measurement and a number of carriers performing the L3 mobility measurement on the first carriers. The second scaling factor is determined by the terminal according to a number of second carriers performing the L3 mobility measurement and a number of carriers performing the L1 mobility measurement on the second carriers.

In an implementation, the first scaling factor may represent a measurement delay of the L1 mobility measurement, and the second scaling factor may represent a measurement delay of the L3 mobility measurement.

In some embodiments, the network device may receive, through the narrow beam, the first message transmitted by the terminal in the PDCCH within the CSI-RS period of the IE csi-SSB-ResourceSet.

In some embodiments, the network device may receive, through the rough beam, the first message transmitted by the terminal in the DCCH or the DL-SCH within the SMTC period of the IE MeasObjectNR.

It is to be noted that the channel for the network device to receive the first message is an example, which is not limited to the embodiment of the present disclosure.

In S802, the network device transmits a response message to the terminal.

The response message is configured to determine, by the terminal, a mobility measurement result of the neighbor cell. The mobility measurement result may include the measurement result of the L1 mobility measurement and the measurement result of the L3 mobility measurement.

In some embodiments, the response message may be a measurement report. For example, the measurement report may include a signal strength and a signal-to-noise ratio. The present disclosure does not limit a specific type of the response message.

In some embodiments, after the response message is transmitted to the terminal, the terminal may determine the mobility measurement result of the neighbor cell according to the response message and a preset threshold value.

In an implementation, in a case where the response message includes the signal strength, the mobility measurement result may be a comparison result between the signal strength of the neighbor cell included in the response message and a preset signal strength threshold. The comparison result can reflect service quality of the neighbor cell.

In some embodiments, the network device may transmit the response message in the DCCH or the DL-SCH within the SMTC period of the IE MeasObjectNR.

In some other embodiments, the network device may transmit the response message in the PDCCH within the CSI-RS period of the IE csi-SSB-ResourceSet.

It is to be noted that the channel for the network device to transmit the response message is an example, which is not limited by the embodiment of the present disclosure.

By using the method, the network device may receive the two first messages that are transmit respectively by the terminal according to the first scaling factor and the second scaling factor. After the network device transmits a first response message and a second response message, the terminal may receive, through the fine beam, the first response message and receive, through the rough beam, the second response message. As the first scaling factor is determined according to the number of the first carriers performing the L1 mobility measurement and the number of the carriers performing the L3 mobility measurement on the first carriers, a process of receiving, by the terminal, the first response message is not interrupted by the second response message. The second scaling factor is determined according to the number of the second carriers performing the L3 mobility measurement and the number of the carriers performing the L1 mobility measurement on the second carriers, so a process of receiving, by the terminal, the second response message is not interrupted by the first response message. Thus, the serving cell throughput and the network mobility performance are improved.

FIG. 9 is a flowchart of a method for measuring mobility according to an example. The method may be performed by the network device in the communication system. As shown in FIG. 9, the method may include S901 and S902.

In S901, the network device receives capability information transmitted by a terminal.

In some embodiments, the network device may receive the capability information transmitted by the terminal before receiving a first message transmitted by the terminal.

In some other embodiments, the network device may also receive the capability information transmitted by the terminal after transmitting a response message to the terminal.

It is to be noted that the present disclosure does not limit a time point of receiving, by the network device, the capability information.

In S902, the network device determines a measurement configuration parameter for the terminal according to the capability information.

In some embodiments, for different measurement types, the network device may determine different measurement configuration parameters of the terminal according to the capability information.

It is to be noted that without contradictions, the present embodiment may be combined with the above embodiments or implementations and various optional solutions of the present disclosure. In the present embodiment, specific implementations of the above steps may also refer to the descriptions in the above embodiments of the present disclosure, which is not repeated in the present disclosure.

In this way, the network device may receive the capability information transmitted by the terminal and perform a measurement configuration according to the capability information.

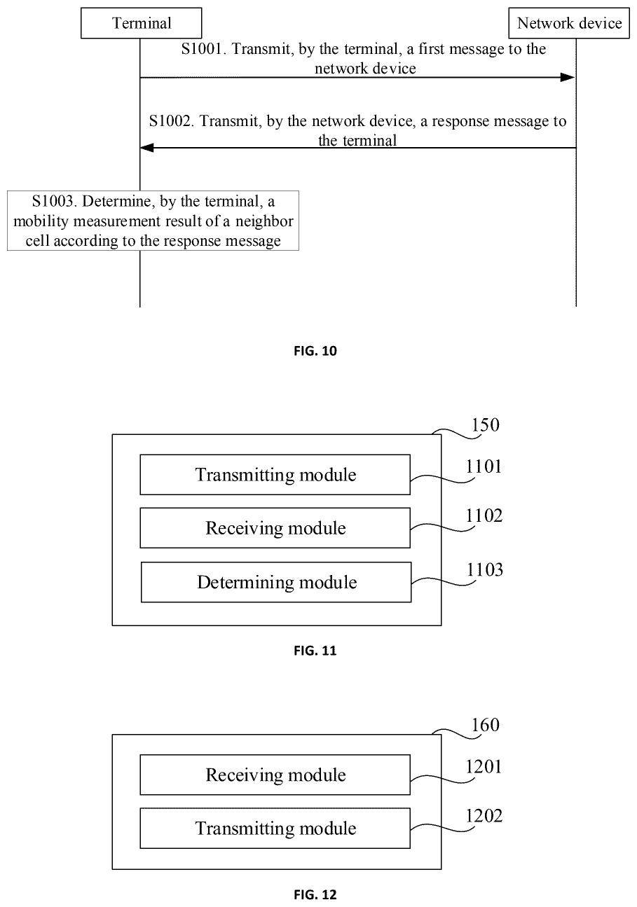

FIG. 10 is a flowchart of a method for measuring mobility according to an example. The method may be performed by the communication system. As shown in FIG. 10, the method may include S1001 to S1003.

In S1001, a terminal transmits a first message to a network device.

The first message may be configured to perform a layer 1 (L1) mobility measurement and a layer 3 (L3) mobility measurement on a neighbor cell.

In S1002, the network device transmits a response message to the terminal.

In S1003, the terminal determines a mobility measurement result of the neighbor cell according to the response message.

The mobility measurement result may include a measurement result of the L1 mobility measurement and a measurement result of the L3 mobility measurement.

It is to be noted that without contradictions, the present embodiment may be combined with the above embodiments or implementations and various optional solutions of the present disclosure. In the present embodiment, specific implementations of the above steps may also refer to the descriptions in the above embodiments of the present disclosure, which is not repeated in the present disclosure.

In this way, the terminal, after transmitting the first message to the network device, may determine the measurement result of the L1 mobility measurement and the measurement result of the L3 mobility measurement through the response message transmitted by the network device, a problem of too many interruptions or prolonged interruptions of a serving cell caused by separately performing the L1 mobility measurement and the L3 mobility measurement is avoided, and thus serving cell throughput and network mobility performance are improved.

FIG. 11 is a block diagram of a terminal 150 according to an example. As shown in FIG. 11, the terminal may include:
a transmitting module 1101 configured to transmit a first message to a neighbor cell;
a receiving module 1102 configured to receive a response message transmitted by the neighbor cell; and
a determining module 1103 configured to determine a mobility measurement result of the neighbor cell according to the response message, where the mobility measurement result includes a measurement result of a layer 1 (L1) mobility measurement and a measurement result of a layer 3 (L3) mobility measurement.

In some embodiments, the transmitting module 1101 is further configured to determine a measurement period according to capability information of the terminal; and transmit the first message to the neighbor cell according to the measurement period.

In some embodiments, the capability information is configured to indicate at least one of the following:
whether the terminal has a capability of determining the mobility measurement result according to the response message received by a specified beam, where the specified beam is any beam of a rough beam or a fine beam;
whether the terminal has a capability of receiving the response message by simultaneously using a rough beam and a fine beam;
whether the terminal has a capability of determining the measurement result of the L1 mobility measurement according to the response message received by a rough beam; or
whether the terminal has a capability of determining the measurement result of the L3 mobility measurement according to the response message received by a fine beam.

In some embodiments, the determining module 1103 is further configured to determine that the capability information indicates a first capability; and determine that the measurement period is at least one of a service measurement timing configuration (SMTC) period in a first information element or a channel state information reference signal (CSI-RS) period in a first information element, where the first information element is an information element measurement object for new radio (IE MeasObjectNR); where the first capability includes at least one of the following: the terminal has the capability of determining the mobility measurement result according to the response message received by the specified beam; the terminal has the capability of receiving the response message by simultaneously using the rough beam and the fine beam; or the terminal has the capability of determining the measurement result of the L1 mobility measurement according to the response message received by the rough beam.

In some embodiments, the determining module 1103 is further configured to determine that the capability information indicates that the terminal has the capability of determining the measurement result of the L3 mobility measurement according to the response message received by the fine beam; and determine that the measurement period is at least one of a synchronization signal block (SSB) period in a second information element or a CSI-RS period in a second information element, where the second information element is an information element channel state information-synchronization signal block resource set (IE csi-SSB-ResourceSet).

In some embodiments, the determining module 1103 is further configured to determine a measurement beam according to the capability information of the terminal; and receive, through the measurement beam, the response message transmitted by the neighbor cell.

In some embodiments, the capability information indicates that the terminal has the capability of determining the mobility measurement result according to the response message received by the specified beam. The determining module 1103 is further configured to determine that the measurement beam is the specified beam.

In some embodiments, the capability information indicates that the terminal has the capability of receiving the response message by simultaneously using the rough beam and the fine beam. The determining module 1103 is further configured to determine that the measurement beam is the rough beam and the fine beam.

In some embodiments, the capability information indicates that the terminal has the capability of determining the measurement result of the L1 mobility measurement according to the response message received by the rough beam. The determining module 1103 is further configured to determine that the measurement beam is the rough beam.

In some embodiments, the capability information indicates that the terminal has the capability of determining the measurement result of the L3 mobility measurement according to the response message received by the fine beam. The determining module 1103 is further configured to determine that the measurement beam is the fine beam.

In some embodiments, the determining module 1103 is further configured to determine that the capability information indicates a second capability; and determine that the measurement period is at least one of an SMTC period in a first information element or a CSI-RS period in a first information element, and at least one of an SSB period in a second information element or a CSI-RS period in a second information element, where the first information element is an IE MeasObjectNR, and the second information element is an IE csi-SSB-ResourceSet. The second capability includes: the terminal does not have a capability of determining the mobility measurement result according to the response message received by a specified beam, where the specified beam is any beam of a rough beam or a fine beam; the terminal does not have a capability of receiving the response message by simultaneously using the rough beam and the fine beam; the terminal does not have a capability of determining the measurement result of the L1 mobility measurement according to the response message received by the rough beam; and the terminal does not have a capability of determining the measurement result of the L3 mobility measurement according to the response message received by the fine beam.

In some embodiments, the transmitting module 1101 is further configured to transmit the first message to the neighbor cell in accordance with at least one of the SSB period in the second information element or the CSI-RS period in the second information element according to a first scaling factor; and transmit the first message to the neighbor cell in accordance with at least one of the SMTC period in the first information element or the CSI-RS period in the first information element according to a second scaling factor; where the first scaling factor is determined according to a number of first carriers performing the L1 mobility measurement and a number of carriers performing the L3 mobility measurement on the first carrier, and the second scaling factor is determined according to a number of second carriers performing the L3 mobility measurement and a number of carriers performing the L1 mobility measurement on the second carriers.

In some embodiments, the response message includes a first response message and a second response message. The receiving module 1102 is further configured to receive the first response message transmitted by the neighbor cell through the fine beam; and receive the second response message transmitted by the neighbor cell through the rough beam.

In some embodiments, the determining module 1103 is further configured to determine the measurement result of the L1 mobility measurement according to the first response message; and determine the measurement result of the L3 mobility measurement according to the second response message.

In some embodiments, the transmitting module 1101 is further configured to transmit the capability information of the terminal to the neighbor cell, where the capability information is configured to determine a measurement configuration parameter for the terminal.

In some embodiments, the first message is configured to perform the L1 mobility measurement and the L3 mobility measurement on the neighbor cell.

FIG. 12 is a block diagram of a network device 160 according to an example. As shown in FIG. 12, the network device may include:
a receiving module 1201 configured to receive a first message transmitted by a terminal; and
a transmitting module 1202 configured to transmit a response message to the terminal, where the response message is configured to determine, by the terminal, a mobility measurement result of a neighbor cell, and the mobility measurement result includes a measurement result of a layer 1 (L1) mobility measurement and a measurement result of a layer 3 (L3) mobility measurement.

In some embodiments, the receiving module 1201 is further configured to receive the first message transmitted by the terminal according to a measurement period, where the measurement period is determined according to capability information of the terminal.

In some embodiments, the capability information is configured to indicate at least one of the following: whether the terminal has a capability of determining the mobility measurement result according to the response message received by a specified beam, where the specified beam is any beam of a rough beam or a fine beam; whether the terminal has a capability of receiving the response message by simultaneously using a rough beam and a fine beam; whether the terminal has a capability of determining the measurement result of the L1 mobility measurement according to the response message received by a rough beam; or whether the terminal has a capability of determining the measurement result of the L3 mobility measurement according to the response message received by a fine beam.

In some embodiments, the measurement period is determined through the following manner: determining that the capability information indicates a first capability; and determining that the measurement period is at least one of a service measurement timing configuration (SMTC) period in a first information element or a channel state information reference signal (CSI-RS) period in a first information element, where the first information element is an IE MeasObjectNR. The first capability includes at least one of the following: the terminal has the capability of determining the mobility measurement result according to the response message received by the specified beam; the terminal has the capability of receiving the response message by simultaneously using the rough beam and the fine beam; or the terminal has the capability of determining the measurement result of the L1 mobility measurement according to the response message received by the rough beam.

In some embodiments, the measurement period is determined through the following manner: determining that the capability information indicates that the terminal has the capability of determining the measurement result of the L3 mobility measurement according to the response message received by the fine beam; and determining that the measurement period is at least one of a synchronization signal block (SSB) period in a second information element or a CSI-RS period in a second information element, where the second information element is an IE csi-SSB-ResourceSet.

In some embodiments, the measurement period is determined through the following manner: determining that the capability information indicates a second capability; and determining that the measurement period is at least one of an SMTC period in a first information element or a CSI-RS period in a first information element, and at least one of an SSB period in a second information element or a CSI-RS period in a second information element, where the first information element is an IE MeasObjectNR, and the second information element is an IE csi-SSB-ResourceSet. The second capability includes: the terminal does not have a capability of determining the mobility measurement result according to the response message received by a specified beam, where the specified beam is any beam of a rough beam or a fine beam; the terminal does not have a capability of receiving the response message by simultaneously using the rough beam and the fine beam; the terminal does not have a capability of determining the measurement result of the L1 mobility measurement according to the response message received by the rough beam; and the terminal does not have a capability of determining the measurement result of the L3 mobility measurement according to the response message received by the fine beam.

In some embodiments, the receiving module 1201 is further configured to receive the first message transmitted by the terminal in accordance with at least one of the SSB period in the second information element or the CSI-RS period in the second information element according to a first scaling factor, and the first message transmitted by the terminal in accordance with at least one of the SMTC period in the first information element or the CSI-RS period in the first information element according to a second scaling factor. The first scaling factor is determined by the terminal according to a number of first carriers performing the L1 mobility measurement and a number of carriers performing the L3 mobility measurement on the first carriers, and the second scaling factor is determined by the terminal according to a number of second carriers performing the L3 mobility measurement and a number of carriers performing the L1 mobility measurement on the second carriers.

In some embodiments, the receiving module 1201 is further configured to receive the capability information transmitted by the terminal.

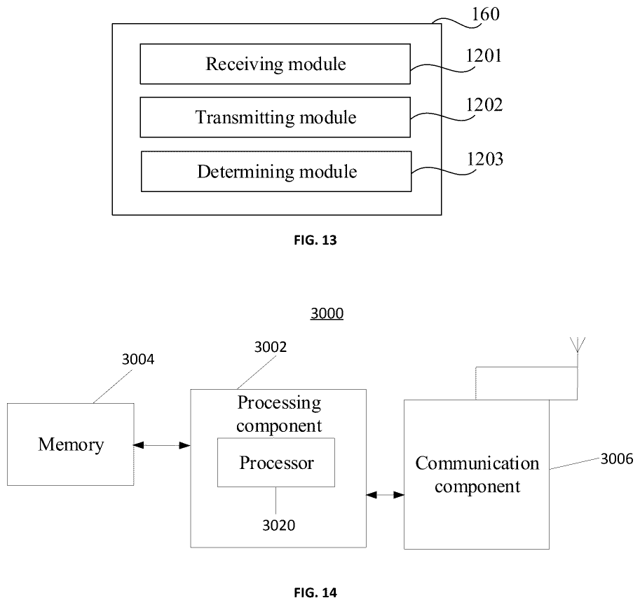

FIG. 13 is a block diagram of a network device 160 according to an example. As shown in FIG. 13, the network device may further include:
a determining module 1203 configured to determine a measurement configuration parameter for the terminal according to the capability information.

For devices in the embodiments, specific manners of performing operations by the respective modules are described in detail in the embodiments related to the method, which is not described in detail in the present disclosure.

FIG. 14 is a block diagram of a communication device according to an example. The communication device 3000 may be a terminal 150 in a communication system 100 shown in FIG. 1 or may also be a network device 160 in the communication system 100.

Referring to FIG. 14, the device 3000 may include one or more components as follows: a processing component 3002, a memory 3004, and a communication component 3006.

The processing component 3002 may be configured to control whole operations of the device 3000, such as operations related to display, phone call, data communication, camera operation, and recording operation. The processing component 3002 may include one or more processors 3020 for performing instructions so as to complete all or some steps of the method for measuring mobility. In addition, the processing component 3002 may include one or more modules to facilitate an interaction between the processing component 3002 and other components. For example, the processing component 3002 may include a multimedia module to facilitate an interaction between a multimedia component and the processing component 3002.

The memory 3004 is configured to store various types of data to support operations on the device 3000. Examples of these data include instructions of any application program or method for operations on the device 3000, data of contacts, data of a telephone directory, messages, pictures, videos, and the like. The memory 3004 may be implemented by any type of a volatile or nonvolatile storage device or a combination of them, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk or an optical disk.

The communication component 3006 is configured to facilitate a wired or wireless communication between the device 3000 and other devices. The device 3000 may access to a wireless network based on a communication standard, such as Wi-Fi, 2G, 3G, 4G, 5G, 6G, NB-IOT, eMTC, or a combination of them. In an example, the communication component 3006 receives a broadcast signal or broadcast related information from an external broadcast management system via a broadcast channel. In an example, the communication component 3006 further includes a near-field communication (NFC) module to facilitate a short-range communication. For example, the NFC module may be implemented based on a radio frequency identification (RFID) technology, an infrared data association (IrDA) technology, an ultra-wideband (UWB) technology, a Bluetooth (BT) technology, and other technologies.

In an example, the device 3000 may be implemented by one or more application-specific integrated circuit (ASIC), digital signal processor (DSP), digital signal processing device (DSPD), programmable logic device (PLD), field-programmable gate array (FPGA), controller, micro-controller, micro-processor, or another electronic element for performing the method for measuring the mobility.

The device 3000 may be an independent electronic device or part of the independent electronic device. For example, the electronic device may be an integrated circuit (IC) or a chip. The integrated circuit may be one IC, or a set of a plurality of ICs. The chip may include, but is not limited to, the following types: a graphics processing unit (GPU), a central processing unit (CPU), a field programmable gate array (FPGA), a digital signal processor (DSP), an application specific integrated circuit (ASIC), or a system on chip (SOC). The integrated circuit or chip may be configured to execute executable instructions (or codes) to implement the method for measuring the mobility. The executable instructions may be stored in the integrated circuit or the chip, or obtained from another apparatus or device. For example, the integrated circuit or the chip includes a processor, a memory, and an interface configured to communicate with other devices. The executable instructions may be stored in the processor. The executable instructions, when executed by the processor, implement the method for measuring the mobility. Alternatively, the integrated circuit or the chip may receive the executable instructions via the interface and transmit the executable instructions to the processor for performing the executable instructions so as to implement the method for measuring the mobility.

In an example, the present disclosure further provides a computer-readable storage medium, storing computer program instructions, where the program instructions, when executed by a processor, implement steps of the method for measuring the mobility provided by the present disclosure. For example, the computer-readable storage medium may be a non-transitory computer-readable storage medium including instructions, for example, may be the memory 3004 including instructions. The instructions may be executed by a processor 3020 of a device 3000 to complete the method for measuring the mobility. For example, the non-transitory computer-readable storage medium may be an ROM, a random access memory (RAM), a CD-ROM, magnetic tape, a floppy disk, or an optical data storage device.

In another example, a computer program product is further provided. The computer program product includes a computer program executable by a programmable device. The computer program has a code part which is configured to, when executed by the programmable device, implement the method for measuring the mobility.

The technical solution provided by the embodiments of the present disclosure may include the following beneficial effects: transmitting the first message to the neighbor cell; receiving the response message transmitted by the neighbor cell; and determining the mobility measurement result of the neighbor cell according to the response message, where the mobility measurement result includes the measurement result of the L1 mobility measurement and the measurement result of the L3 mobility measurement. In this way, the terminal, after transmitting the first message to the neighbor cell, may determine the measurement result of the L1 mobility measurement and the measurement result of the L3 mobility measurement through the response message transmitted by the neighbor cell, a problem of too many interruptions or prolonged interruptions of a serving cell caused by separately performing the L1 mobility measurement and the L3 mobility measurement is avoided, and thus serving cell throughput and network mobility performance are improved.

As used herein, the term “processor” may refer to one processor that performs the defined functions or a plurality of processors that collectively perform defined functions, such that the execution of the individual defined functions may be divided amongst such processors.

After considering the specification and practicing the present disclosure, those skilled in the art can easily figure out other implementation solutions of the present disclosure. The present application is intended to cover any transformation, purpose or adaptive change of the present disclosure. These transformations, purposes or adaptive changes comply with a general principle of the present disclosure and include common general knowledge or conventional technical means in the technical field not disclosed by the present disclosure. The specification and the embodiments are regarded as examples, and the true scope and spirit of the present disclosure are indicated by the following claims.

It is to be understood that the present disclosure is not limited to the described precise structure shown in the accompanying drawings, and various modifications and variations may be made without departing from the scope. The scope of the present disclosure is merely limited by the appended claims.

1. A method for measuring mobility, performed by a terminal, the method comprising:
transmitting a first message to a neighbor cell;
receiving a response message transmitted by the neighbor cell; and
determining a mobility measurement result of the neighbor cell according to the response message, wherein the mobility measurement result comprises a measurement result of a layer 1 (L1) mobility measurement and a measurement result of a layer 3 (L3) mobility measurement.

2. The method according to claim 1, wherein transmitting the first message to the neighbor cell comprises:
determining a measurement period according to capability information of the terminal; and
transmitting the first message to the neighbor cell according to the measurement period.

3. The method according to claim 2, wherein the capability information is configured to indicate at least one of the following:
whether the terminal has a capability of determining the mobility measurement result according to the response message received by a specified beam, wherein the specified beam is any beam of a rough beam or a fine beam;
whether the terminal has a capability of receiving the response message by simultaneously using a rough beam and a fine beam;
whether the terminal has a capability of determining the measurement result of the L1 mobility measurement according to the response message received by a rough beam; or
whether the terminal has a capability of determining the measurement result of the L3 mobility measurement according to the response message received by a fine beam.

4. The method according to claim 3, wherein determining the measurement period according to the capability information of the terminal comprises:
determining that the capability information indicates a first capability; and
determining that the measurement period is at least one of a service measurement timing configuration (SMTC) period in a first information element or a channel state information reference signal (CSI-RS) period in a first information element, wherein the first information element is an information element measurement object for new radio (IE MeasObjectNR);
wherein the first capability comprises at least one of the following:
the terminal has the capability of determining the mobility measurement result according to the response message received by the specified beam;
the terminal has the capability of receiving the response message by simultaneously using the rough beam and the fine beam; or
the terminal has the capability of determining the measurement result of the L1 mobility measurement according to the response message received by the rough beam;
or
wherein determining the measurement period according to the capability information of the terminal comprises:
determining that the capability information indicates that the terminal has the capability of determining the measurement result of the L3 mobility measurement according to the response message received by the fine beam; and
determining that the measurement period is at least one of a synchronization signal block (SSB) period in a second information element or a channel state information reference signal (CSI-RS) period in a second information element, wherein the second information element is an information element channel state information-synchronization signal block resource set (IE csi-SSB-ResourceSet).

5. (canceled)

6. The method according to claim 3, further comprising:
determining a measurement beam according to the capability information of the terminal;
wherein receiving the response message transmitted by the neighbor cell comprises:
receiving, through the measurement beam, the response message transmitted by the neighbor cell.

7. The method according to claim 6, wherein the capability information indicates that the terminal has the capability of determining the mobility measurement result according to the response message received by the specified beam; and
determining the measurement beam according to the capability information of the terminal comprises:
determining that the measurement beam is the specified beam;
or
wherein the capability information indicates that the terminal has the capability of receiving the response message by simultaneously using the rough beam and the fine beam; and
determining the measurement beam according to the capability information of the terminal comprises:
determining that the measurement beam is the rough beam and the fine beam;
or
wherein the capability information indicates that the terminal has the capability of determining the measurement result of the L1 mobility measurement according to the response message received by the rough beam; and
determining the measurement beam according to the capability information of the terminal comprises:
determining that the measurement beam is the rough beam;
or
wherein the capability information indicates that the terminal has the capability of determining the measurement result of the L3 mobility measurement according to the response message received by the fine beam; and
determining the measurement beam according to the capability information of the terminal comprises:
determining that the measurement beam is the fine beam.

8-10. (canceled)

11. The method according to claim 2, wherein determining the measurement period according to the capability information of the terminal comprises:
determining that the capability information indicates a second capability; and
determining that the measurement period is at least one of a service measurement timing configuration (SMTC) period in a first information element or a channel state information reference signal (CSI-RS) period in a first information element, and at least one of a synchronization signal block (SSB) period in a second information element or a CSI-RS period in a second information element, wherein the first information element is an information element measurement object for new radio (IE MeasObjectNR), and the second information element is an information element channel state information-synchronization signal block resource set (IE csi-SSB-ResourceSet);
wherein the second capability comprises:
the terminal does not have a capability of determining the mobility measurement result according to the response message received by a specified beam, wherein the specified beam is any beam of a rough beam or a fine beam;
the terminal does not have a capability of receiving the response message by simultaneously using the rough beam and the fine beam;
the terminal does not have a capability of determining the measurement result of the L1 mobility measurement according to the response message received by the rough beam; and
the terminal does not have a capability of determining the measurement result of the L3 mobility measurement according to the response message received by the fine beam.

12. The method according to claim 11, wherein transmitting the first message to the neighbor cell according to the measurement period comprises:
transmitting the first message to the neighbor cell in accordance with at least one of the SSB period in the second information element or the CSI-RS period in the second information element according to a first scaling factor; and
transmitting the first message to the neighbor cell in accordance with at least one of the SMTC period in the first information element or the CSI-RS period in the first information element according to a second scaling factor;
wherein the first scaling factor is determined according to a number of first carriers performing the L1 mobility measurement and a number of carriers performing the L3 mobility measurement on the first carriers, and the second scaling factor is determined according to a number of second carriers performing the L3 mobility measurement and a number of carriers performing the L1 mobility measurement on the second carriers.

13. The method according to claim 12, wherein the response message comprises a first response message and a second response message, and receiving the response message transmitted by the neighbor cell comprises:
receiving, through the fine beam, the first response message transmitted by the neighbor cell; and
receiving, through the rough beam, the second response message transmitted by the neighbor cell.

14. The method according to claim 13, wherein determining the mobility measurement result of the neighbor cell according to the response message comprises:
determining the measurement result of the L1 mobility measurement according to the first response message; and
determining the measurement result of the L3 mobility measurement according to the second response message.

15. The method according to claim 2, wherein the method further comprises:
transmitting the capability information of the terminal to the neighbor cell, wherein the capability information is configured to determine a measurement configuration parameter for the terminal.

16. The method according to claim 1, wherein the first message is configured to perform the L1 mobility measurement and the L3 mobility measurement on the neighbor cell.

17. A method for measuring mobility, performed by a network device, the method comprising:
receiving a first message transmitted by a terminal; and
transmitting a response message to the terminal, wherein the response message is configured to determine, by the terminal, a mobility measurement result of a neighbor cell, and the mobility measurement result comprises a measurement result of a layer 1 (L1) mobility measurement and a measurement result of a layer 3 (L3) mobility measurement.

18. The method according to claim 17, wherein receiving the first message transmitted by the terminal comprises:
receiving the first message transmitted by the terminal according to a measurement period, wherein the measurement period is determined according to capability information of the terminal.

19. The method according to claim 18, wherein the capability information is configured to indicate at least one of the following:
whether the terminal has a capability of determining the mobility measurement result according to the response message received by a specified beam, wherein the specified beam is any beam of a rough beam or a fine beam;
whether the terminal has a capability of receiving the response message by simultaneously using a rough beam and a fine beam;
whether the terminal has a capability of determining the measurement result of the L1 mobility measurement according to the response message received by a rough beam; or
whether the terminal has a capability of determining the measurement result of the L3 mobility measurement according to the response message received by a fine beam.

20. The method according to claim 19, wherein the measurement period is determined via the following:
determining that the capability information indicates a first capability; and
determining that the measurement period is at least one of a service measurement timing configuration (SMTC) period in a first information element or a channel state information reference signal (CSI-RS) period in a first information element, wherein the first information element is an information element measurement object for new radio (IE MeasObjectNR);
wherein the first capability comprises at least one of the following:
the terminal has the capability of determining the mobility measurement result according to the response message received by the specified beam;
the terminal has the capability of receiving the response message by simultaneously using the rough beam and the fine beam; or
the terminal has the capability of determining the measurement result of the L1 mobility measurement according to the response message received by the rough beam;
or
wherein the measurement period is determined via the following:
determining that the capability information indicates that the terminal has the capability of determining the measurement result of the L3 mobility measurement according to the response message received by the fine beam; and
determining that the measurement period is at least one of a synchronization signal block (SSB) period in a second information element or a channel state information reference signal (CSI-RS) period in a second information element, wherein the second information element is an information element channel state information-synchronization signal block resource set (IE csi-SSB-ResourceSet).

21. (canceled)

22. The method according to claim 18, wherein the measurement period is determined via the following:
determining that the capability information indicates a second capability; and
determining that the measurement period is at least one of a service measurement timing configuration (SMTC) period in a first information element or a channel state information reference signal (CSI-RS) period in a first information element, and at least one of a synchronization signal block (SSB) period in a second information element or a CSI-RS period in a second information element, wherein the first information element is an information element measurement object for new radio (IE MeasObjectNR), and the second information element is an information element channel state information-synchronization signal block resource set (IE csi-SSB-ResourceSet);
wherein the second capability comprises:
the terminal does not have a capability of determining the mobility measurement result according to the response message received by a specified beam, wherein the specified beam is any beam of a rough beam or a fine beam;
the terminal does not have a capability of receiving the response message by simultaneously using the rough beam and the fine beam;
the terminal does not have a capability of determining the measurement result of the L1 mobility measurement according to the response message received by the rough beam; and
the terminal does not have a capability of determining the measurement result of the L3 mobility measurement according to the response message received by the fine beam.

23. The method according to claim 22, wherein receiving the first message transmitted by the terminal according to the measurement period comprises:
receiving the first message transmitted by the terminal in accordance with at least one of the SSB period in the second information element or the CSI-RS period in the second information element according to a first scaling factor, and the first message transmitted by the terminal in accordance with at least one of the SMTC period in the first information element or the CSI-RS period in the first information element according to a second scaling factor;
wherein the first scaling factor is determined by the terminal according to a number of first carriers performing the L1 mobility measurement and a number of carriers performing the L3 mobility measurement on the first carriers, and the second scaling factor is determined by the terminal according to a number of second carriers performing the L3 mobility measurement and a number of carriers performing the L1 mobility measurement on the second carriers.

24. The method according to claim 18, wherein the method further comprises
receiving the capability information transmitted by the terminal; and
determining a measurement configuration parameter for the terminal according to the capability information.

25-27. (canceled)

28. A terminal, comprising:
one or more processors; and
a memory configured to store processor-executable instructions;
wherein the one or more processors are collectively configured to:
transmit a first message to a neighbor cell;
receive a response message transmitted by the neighbor cell; and
determine a mobility measurement result of the neighbor cell according to the response message, wherein the mobility measurement result comprises a measurement result of a layer 1 (L1) mobility measurement and a measurement result of a layer 3 (L3) mobility measurement.

29-30. (canceled)
